(19) United States
(12) Patent Application Publication
(10) Pub. No.: US 2025/0130365 A1
(43) Pub. Date: Apr. 24, 2025

(54) SINGLE MODE OPTICAL FIBER OPTIMIZED TO OPERATE IN O AND E BAND, AND CORRESPONDING OPTICAL TRANSMISSION SYSTEM

(71) Applicant: Draka Comteq France SAS, Paron (FR)

(72) Inventors: Louis-Anne De Montmorillon, Paron (FR); Pierre Sillard, Paron (FR); Lionel PROVOST, Paron (FR)

(21) Appl. No.: 18/911,950

(22) Filed: Oct. 10, 2024

(30) Foreign Application Priority Data
Oct. 18, 2023 (FR) 2311265

(51) Int. Cl. G02B 6/036; G02B 6/02; G02B 6/028

(52) U.S. Cl. CPC G02B 6/0365; G02B 6/02028; G02B 6/02214; G02B 6/0281; G02B 6/03611

(57) ABSTRACT

A single-mode optical fiber including a core having a refractive index n, wherein the core comprises a region in which the value of n decreases from a value n₀, to a value n₂; and a cladding having
a first layer of cladding in which the refractive index is n₂; and
a second layer of cladding in which the refractive index is n₃, lower than n₂;
a third layer of cladding in which the refractive index is n₄, higher than n₃;
   in which the core radius r₁ is comprised between 2.5 μm and 5.5 μm; and
   in which a refractive-index difference Δn₀=n₀−n₄ is higher than 5.8×10⁻³; and
   in which a refractive-index difference Δn₂=n₂−n₄ is between 1×10⁻³ and 2.5×10⁻³; and in which
   a refractive-index difference Δn₃=n₃−n₄ is lower than 0.

### TECHNICAL FIELD

The present disclosure relates to single-mode optical fibers used in optical transmission systems, and optical transmission systems comprising such single mode fibers. More specifically, the present invention relates to single-mode optical fibers, which are optimized to operate in O and E wavelength bands.

### BACKGROUND

Telecommunication systems require optical fibers, which are capable of transmitting signals for a long distance without degradation. Such optical-fiber transmission systems often use single-mode optical fibers (SMFs), such as, for example, so-called “standard” single-mode fibers (SSMFs), which are used in terrestrial transmission systems. Indeed, a single-mode optical fiber (SMF) allows to obtain a lower attenuation of the optical signal in comparison with a multi-mode optical fiber (MMF), and therefore, is more suitable for long-distance transmissions. Furthermore, as indicated by its name, a multimode fiber presents a plurality of modes, each with different speeds, which induces a limited bandwidth, contrary to a single-mode optical fiber which theoretically presents an unlimited bandwidth, more suitable for long-distance transmissions.

Furthermore, to facilitate compatibility between optical systems from different manufacturers, the International Telecommunication Union (ITU) has defined several standards with which a standard optical transmission fiber should comply. Among these standards, the ITU-T G. 652 recommendation (Last revision of November 2016) describes the characteristics of single-mode fiber and cable-based networks, which can answer the growing demand for broadband services. The ITU-T G.652 recommendation (herein after “G.652”) has several attributes (i.e. A, B, C and D) defining the fiber attributes of a single mode optical fiber. The ITU-T G.657 (herein after “G.657”) recommendation focuses more precisely on bending-loss insensitive single-mode fibers. More particularly, the attributes of the G.657.A1 and G.657.A2 (Last revision of November 2016) are presented below.

Different optical wavelength communication bands can be used to transmit information through an optical fiber. These bands correspond to a wavelength region where optical fibers have smaller transmission losses. This low-loss wavelength region ranges from 1260 nm to 1625 nm, and is divided into five wavelength bands referred to as the O-, E-, S-, C- and L-bands.

Presently, most of the single mode optical fibers are operating at wavelength ranging from typically 1260 nm to 1625 nm, and more particularly in the O-band (1260-1360 nm) and the C&L-bands (1530-1625 nm), which is the case of G.652 and G.657 optical fibers.

More particularly, the optical performances of G.657 category A are: a Mode Field Diameter (MFD) for a 1310 nm wavelength comprised between 8.6 and 9.2 μm, a cable Cutoff below 1260 nm, and a Zero Dispersion Wavelength (ZDW) comprised between 1300 and 1324 nm (such ZDW is optimal for the use of fibers in the O-band), and a Zero Dispersion Slope (ZDS) lower or equal to 0.092 ps/(nm²·km).

The maximum accepted macrobend losses of G.657 fibers are:

TABLE 1

| | G.657.A1 | G.657.A2 |
|---|---|---|
| 10 turns at radius of 15 mm, measured | 0.25 dB | 0.03 dB |
| at 1550 nm (R15BL at 1550) | | |
| 10 turns at radius of 15 mm, measured | 1.0 dB | 0.1 dB |
| at 1625 nm (R15BL at 1625) | | |
| 1 turn at radius of 10 mm, measured at | 0.75 dB | 0.1 dB |
| 1550 nm (R15BL at 1550) | | |
| 1 turn at radius of 10 mm, measured at | 1.0 dB | 0.2 dB |
| 1625 nm (R15BL at 1625) | | |
| 1 turn at radius of 7.5 mm, measured at | | 0.5 dB |
| 1550 nm (R15BL at 1550) | | |
| 1 turn at radius of 7.5 mm, measured at | | 1.0 dB |
| 1625 nm (R15BL at 1625) | | |

The international applications WO2015/092464 and WO2019/122943 disclose examples of optical fibers with Zero Dispersion wavelength between 1300 and 1324 nm as according to G.652 and G.657A.

However, with the long-term trend towards more and more expanding the transmission capacities, as data traffic keeps growing at a large rate, there is a need to optimize the use of the wavelengths at the top of the O-band used for optical fiber communications because the chromatic dispersion will be too high at these wavelengths for existing equipment. More particularly, Metro Wave Division Multiplexing (MWDM) systems with 25G transceivers, for example, are expected to operate in both O and E bands, from 1268 to 1375 nm, and need chromatic dispersion ranging from −9.5 to +3 ps/(nm²·km): this is not achieved with today G.652 and G657.A fibers because the zero-dispersion wavelength is ranging from 1300 to 1324 nm. Therefore, there is a need to find an optical fiber design able to answer this need.

### SUMMARY OF THE INVENTION

These objectives are achieved by the invention, which concerns a single-mode optical fiber comprising:
a core having a refractive index n, wherein the core comprises a region in which the value of n decreases from a value n₀ at a radius r₀, to a value n₂ at a radius r₁; and
a cladding having a refractive index n′, said cladding comprising:
a first layer of cladding wherein the refractive index n′ is equal to n₂; and
a second layer of cladding wherein the refractive index n′ is equal to a value ng lower than n₂;
a third layer of cladding wherein the refractive index n′ is equal to a value n₄ higher than n₃;
   wherein the core radius r₁ is comprised between 2.5 μm and 5.5 μm; and
   wherein a refractive-index difference Δn₀=n₀−n₄ is higher than 5.8×10⁻³; and
   wherein a refractive-index difference Δn₂=n₂−n₄ is between 1×10⁻³ and 2.5×10⁻³; and
   wherein a refractive-index difference Δn₃=n₃−n₄ is lower than 0
   wherein the refractive-index profile of the core and cladding is defined by the following profile parameters:

$${K}_{1} = {V}_{11} - 5.85 \times {V}_{01}$$

$${K}_{2} = {V}_{02} + 0.65 \times {V}_{01}$$

$${K}_{3} = {V}_{03} - 5 \times {K}_{2}$$

where
V₀₁ (μm) is a surface integral of the core;
V₁₁ (μm²) is a volume integral of the core;
V₀₂ (μm) is a surface integral of the first layer of cladding;
V₀₃ (μm) is a surface integral of the second layer of cladding;
and wherein said parameters respect the following inequalities:

$$- 59 < {K}_{1} < - 47$$

$$18 < {K}_{2} < 24$$

$$- 133 < {K}_{3} < - 118$$

Thus, this invention allows to obtain optical fibers operating optimally in the O and E wavelength bands, thus with a Chromatic Dispersion (CD) slightly shifted in comparison to the G.652 and G.657 fibers but presenting the same optical performances. More particularly, the optical fiber according to the invention presents the same properties as the G.657.A fibers: a MFD-1310 at 9.0 μm, a cable Cutoff below 1260 nm and low bend losses; except for the ZDW which is comprised between 1340 and 1360 nm.

Therefore, the optical fiber according to the invention allow to maintain the chromatic dispersion between −9 and +3 ps/(nm·km) in the range from 1268 to 1375 nm.

Therefore, the invention is ideal for use in Metro Wave Division Multiplexing (MWDM) systems. These systems allow to double the number of wavelength channels under the same conditions as in the commonly used Coarse Wavelength Division Multiplexing (CWDM) systems, by reducing the wavelength spacing of CWDM from 20 nm to 10 nm.

Ultimately, Metro Wave Division Multiplexing (MWDM) is proposed to meet the urgent needs of 5G commercialization. And, as it only makes parameter adjustments based on the mature CWDM technology, therefore, the industry can reuse the CWDM modules production process, and the industry chain can quickly meet market demand.

According to a particular embodiment, the third layer of cladding is composed of silica.

According to a particular aspect of the invention, the profile of the refractive index or the core is trapezoidal, with a ratio comprised between 0 and 1, and preferably between 0.05 and 0.95, wherein said ratio is equal to r₀/r₁.

According to another particular aspect of the invention, the profile of the refractive index or the core presents rounded edges.

According to a particular embodiment, the profile of the refractive index of the core presents an inner central depressed zone, from the center of the core to the radius r₀, wherein r₀ is lower than r₁, and wherein the refractive index n of the core, presents a minimum value at the center of the core equal to n_{0D}, wherein n_{0D} is lower than n₀.

According to a particular aspect of the invention, the region with decrease of refractive index is obtained by gradually changing a concentration of at least two dopants.

According to an embodiment of the invention, the at least two dopants are chosen among the following elements and/or molecules:
germanium oxide (GeO₂);
fluorine (F);
phosphorus oxide (P_{X}O_{Y});
boron oxide (B_{X}O_{Y});
aluminum oxide (Al₂O₃).

According to a particular aspect of the invention, said optical fiber has a Chromatic Dispersion comprised between −9 and +3 ps/(nm·km) in the range of wavelength from 1268 to 1375 nm.

Therefore, the Chromatic Dispersion is slightly shifted in comparison with the G.562 and G.567 optical fibers, which allows to operate in both the O- and E-wavelength bands.

According to an embodiment of the invention, said optical fiber has a Mode Field Diameter (MFD) at a 1310 nm wavelength which is comprised between 8.6 and 9.2 μm and preferably at 9 μm.

According to a particular aspect of the invention, said optical fiber has a Cable cut-off wavelength comprised between 1170 nm and 1260 nm.

According to a particular aspect of the invention, the optical fiber has a Zero Dispersion Wavelength comprised between 1340 and 1360 nm.

The invention also relates to an optical fiber transmission system which comprises at least one single-mode optical fiber as described previously.

Therefore, the range of wavelength which can be used by this system is wider than the ones available for the optical communication system of the prior art. In fact, it can operate in the O- and E-wavelength bands (from 1268 to 1375 nm) using, for example, Metro Wave Division Multiplexing (MWDM) with a 25 Gb/s transceiver.

According to an embodiment of the invention, the optical fiber transmission system has a maximum Transmitter Dispersion Penalty of 1.5 dB.

### BRIEF DESCRIPTION OF THE FIGURES

The present disclosure can be better understood with reference to the following description and drawings, given by way of example and not limiting the scope of protection, and in which:

FIG. 1 depicts an optical fiber according to the invention;

FIG. 2 depicts a diagrammatic representation of the evolution of the refractive index (a) of the core and cladding of an optical fiber according to FIG. 1, according to a first example of invention, together with a sectional view (b) of such optical fiber;

FIG. 3 depicts a diagrammatic representation of the evolution of the refractive index of the core and cladding of an optical fiber according to FIG. 3, according to a second example of the invention, the refractive index profile of the core comprising rounded edges;

FIG. 4 depicts a diagrammatic representation of the evolution of the refractive index of the core and cladding of an optical fiber according to FIG. 3, according to a third example of the invention, the refractive index profile of the core comprising a depressed central zone;

FIG. 5 depicts a diagrammatic representation of the evolution of the refractive index of the core and cladding of an optical fiber according to FIG. 3, according to a fourth example of the invention, the refractive index profile of the core comprising a depressed central zone, and rounded edges;

FIG. 6 depicts a diagrammatic representation of a transmission system comprising an optical fiber according to the invention.

The components in the figures are not necessarily to scale, emphasis instead being placed upon illustrating the principles of the invention.

### DETAILED DESCRIPTION

The general principle of the invention relies on a single-mode optical fiber configured to be implemented in optical transmission systems operating in a range of wavelengths comprised between 1260 nm and 1625 nm. More particularly, the invention relies on a single-mode optical fiber optimized to be used in the highest wavelengths of the O-band and even in the E-band (for example, around 1375 nm). Indeed, the specific characteristics of the single-mode optical fiber according to the invention allow to obtain a Chromatic Dispersion (CD) slightly shifted in comparison to the G.652 and G.657 fibers but presenting the same optical performances. More particularly, the single-mode optical fiber according to the invention presents a ZDW comprised between 1340 and 1360 nm, allowing to maintain the Chromatic Dispersion (CD) between −9 and +3 ps/(nm·km) in the range from 1268 to 1375 nm. Such ZDW and all other optical parameters are obtained thanks to specific characteristics of the different elements composing the fiber. Furthermore, as for G.652 and G.657 fibers, the optical fiber according to the invention has a Mode Field Diameter (MFD) at a 1310 nm wavelength which is comprised between 8.6 and 9.2 μm and preferably at 9 μm. The optical fiber also has a Cable cut-off wavelength comprised between 1170 nm and 1260 nm. Thus, this optical fiber presents similar characteristics to the G.652 and G.657 fibers, but is further optimized for a use in the high O-band wavelengths.

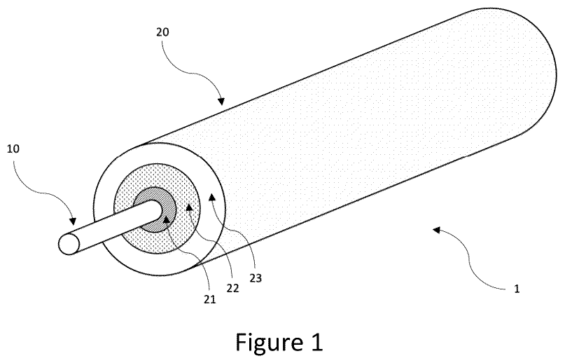

As illustrated in [FIG. 1], the optical fiber 1 according to the invention comprises a core 10 which is the inner light-carrying member of the fiber, and a cladding 20 which serves to confine the light to the core. The cladding comprises three layers of cladding: a first layer of cladding 21 also referred to as an “intermediate cladding”, a second layer of cladding 22 also referred to as a “trench”, and a third layer of cladding 23 also referred to as “external cladding”.

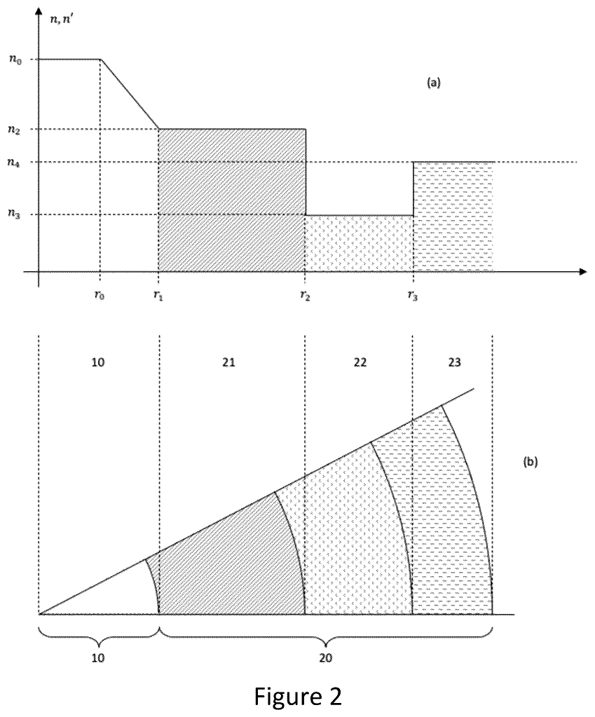

The core 10 is defined by a radius r and a refractive index n varying with radius r, while the cladding is defined be a radius r′ and a refractive index n′ varying with radius r′. More particularly, [FIG. 2] represents the index profile of an optical fiber on the above graph (a) and a sectional view of this optical fiber in the part below (b), according to the invention. In the part (a) of this figure is represented the evolution of the refractive index (n, n′) of the core 10 and cladding 20 in function of the radius (r, r′) from the center of the core 10.

According to the invention, the core 10 is defined with an external radius r₁. The core 10 comprises a first region, from its center (r=0) to a radius r₀. In the embodiment illustrated in [FIG. 2], the first region of the core presents a constant refractive index equal to no. The optical core 10 further comprises a second region, from radius r₀ to radius r₁, with a decreasing refractive index, and with a refractive index n₂ at radius r₁. In the embodiment illustrated in [FIG. 2], the index of the core in the second region decreases from no to n₂. Furthermore, in the exemplary embodiment of [FIG. 2], the radiuses and indices of the core are defined as follow:

$$0.1 \; 80 µm \leq {r}_{0} \leq 3 µm$$

$$2.5 µm \leq {r}_{1} \leq 5.5 µm$$

$${r}_{0} \leq {r}_{1}$$

Δn₀>0.0058 with Δn₀ being the refractive index difference between the first region of the core and the third layer of cladding: Δn₀=n₀−n₄
1×10⁻³≤Δn₂≤2.5×10⁻³ with Δn₂ being the difference between the index at r₁ (in the outer part of the second region of the core) and the index of the third layer of cladding: Δn₂=n₂−n₄

More particularly, according to a particular embodiment of the invention, Δn₀ is comprised between 0.0058 and 0.0085.

In addition, the radiuses parameters of the core 10 can further be defined as follows: 0≤r₀≤r₁ with the ratio between the radius of the first region and the second region of the cladding being defined as follows: ratio=r₀/r₁, with 0≤ratio≤1, and preferably, 0.05≤ratio≤0.95.

Thus, the core 10 also presents a radius equivalent r_{eq} defined as follows:

r_{eq}=r₁×(1+ratio)/2, with 1.5 μm≤r_{eq}≤3.5 μm

Furthermore, the profile of the refractive index of the core 10 can be trapezoidal or rectangular, with edges which can be rounded or not.

The values of index and radius contribute to obtaining a single-mode optical fiber optimized for operating in the high wavelengths of the O-band. Indeed, the core radius of the single-mode optical fiber according to the invention is smaller than the prior art's ones, which allow to obtain a ZDW around 1350 nm.

The surface integral of the core 10 can be expressed by the following formula:

$${V}_{01} = {\int }_{0}^{{r}_{1}} Δ n ( r ) \cdot dr \approx \frac{{r}_{1}}{2} \cdot [ Δ {n}_{0} \cdot ( 1 + ratio ) + Δ {n}_{2} \cdot ( 1 - ratio ) ]$$

In this formula, the index deltas (Δn₀, Δn₂) are multiplied by 1000, the unit of r₁ is the μm, and therefore, the unit of V₀₁ is the μm.

In a particular embodiment of the invention: 16 μm≤V₀₁≤25 μm.

And the volume integral of the core 10 can be expressed by the following formula:

$${V}_{11} = 2 \cdot {\int }_{0}^{{r}_{1}} Δ n ( r ) \cdot r \cdot dr \approx \frac{{r}_{1}^{2}}{3} \cdot [ Δ {n}_{0} \cdot ( 1 + ratio + {ratio}^{2} ) + Δ {n}_{2} \cdot ( 2 - ratio - {ratio}^{2} ) ]$$

In this formula, the index deltas (Δn₀, Δn₂) are multiplied by 1000, the unit of r₁ is the μm, and therefore, the unit of V₁₁ is the μm².

In a particular embodiment of the invention: 42 μm²≤V_{11≤93} μm².

The first layer of cladding 21 or “intermediate cladding” is defined with a radius r₂ and a constant refractive index equal to n₂.

According to an embodiment of the invention, the radius of the first layer of cladding 21 is preferably defined as follows: 7.8 μm≤r₂≤9 μm.

The surface integral of the first layer of cladding 21 can be expressed by the following formula:

$${V}_{02} = {\int }_{{r}_{1}}^{{r}_{2}} Δ n ( r ) \cdot dr \approx ( {r}_{2} - {r}_{1} ) \cdot Δ {n}_{2}$$

In this formula, the index delta Δn₂ is multiplied by 1000, the unit of r₁ and r₂ is the μm, and therefore, the unit of V₀₂ is the μm.

In a particular embodiment of the invention: 3 μm≤V₀₂≤12 μm.

The volume integral of the first layer of cladding 21 can be expressed by the following formula:

$${V}_{12} = 2 \cdot {\int }_{{r}_{1}}^{{r}_{2}} Δ n ( r ) \cdot r \cdot dr \approx ( {r}_{2}^{2} - {r}_{1}^{2} ) \cdot Δ {n}_{2}$$

In this formula, the index delta Δn₂ is multiplied by 1000, the unit of r₁ and r₂ is the μm, and therefore, the unit of V₁₂ is the μm².

In a particular embodiment of the invention: 50 μm²≤V₁₂≤130 μm².

The second layer of cladding 22 or “trench” is defined with a radius r₃ and a constant refractive index n₃, the index of the second layer of cladding being defined as follows: Δn_{3≤0}, with Δn₃ being the refractive-index difference between the second layer of cladding 22 and the third layer of cladding 23: Δn₃=n₃−n₄ Furthermore, according to a particular embodiment of the invention, the radius of the second layer of cladding 22 is preferably defined as follows: 10.8 μm≤r₃≤13.2 μm.

The surface integral of the second layer of cladding 22 can be expressed by the following formula:

$${V}_{03} = {\int }_{{r}_{2}}^{{r}_{3}} Δ n ( r ) \cdot dr \approx ( {r}_{3} - {r}_{2} ) \cdot Δ {n}_{3}$$

In this formula, the index delta Δn₃ is multiplied by 1000, the unit of r₂ and r₃ is the μm, and therefore, the unit of V₀₃ is the μm.

In a particular embodiment of the invention: −30 μm≤V₀₃≤−14 μm.

The volume integral of the second layer of cladding 22 can be expressed by the following formula:

$${V}_{13} = 2 \cdot {\int }_{{r}_{2}}^{{r}_{3}} Δ n ( r ) \cdot r \cdot dr \approx ( {r}_{3}^{2} - {r}_{2}^{2} ) \cdot Δ {n}_{3}$$

In this formula, the index delta Δn₃ is multiplied by 1000, the unit of r₂ and r₃ is the μm, and therefore, the unit of V₁₃ is the μm².

In a particular embodiment of the invention: −653 μm²≤V₁₃≤−272 μm².

Thus, the single-mode optical fiber 1 according to the invention requires a trench assisted design with a lower refractive index compared to the second layer of cladding, to reach the targeted performances, i.e. a ZDW comprised between 1340 and 1360 nm and a shifted CD and the same other parameters as G.652 and G.657 fibers.

Finally, the third layer of cladding 23 or “external cladding” is defined with a constant refractive index n₄ which respects the following inequality: n₄≥n₃.

This third layer of cladding 23 participates in creating a trench in the second layer of cladding 22, and to protect the inner layers of cladding 20 and the core 10.

The third layer of cladding 23 is preferably composed of almost pure silica, and preferably pure silica.

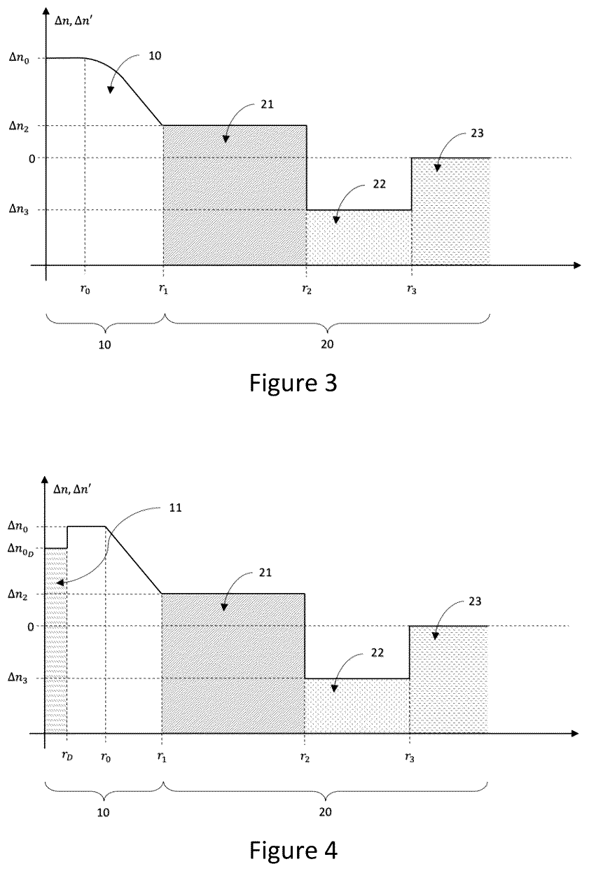

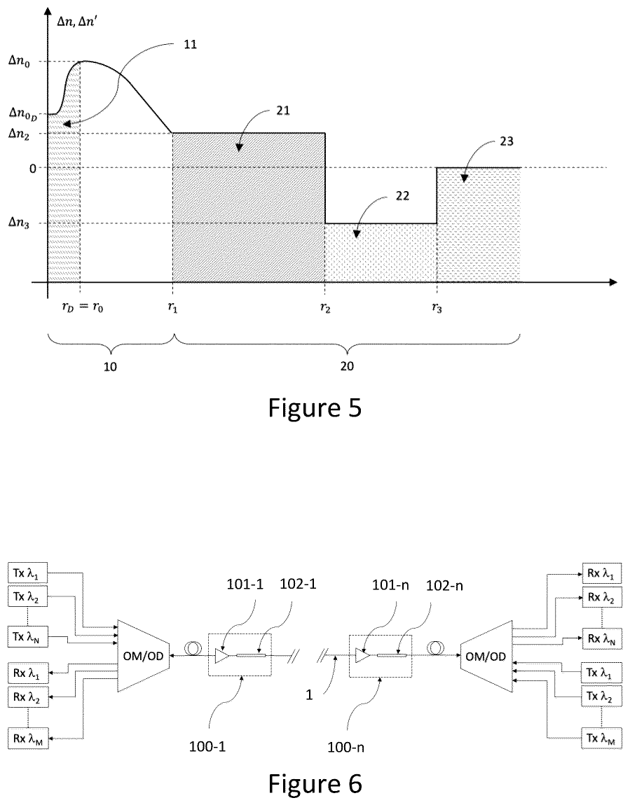

Hereinafter are described specific embodiments of the invention. More particularly, the invention can present specific refractive-index profiles which are described in relation with [FIG. 2], [FIG. 3], [FIG. 4] and [FIG. 5], which are not limiting examples.

According to the invention, the refractive-index profile of the core 10 and the cladding 20 of the optical fiber 1 are described in relation with profile parameters (K₁, K₂, K₃), which are defined as follows:

$${K}_{1} = {V}_{11} - 5.85 \times {V}_{01}$$

$${K}_{2} = {V}_{02} + 0.65 \times {V}_{01}$$

$${K}_{3} = {V}_{03} - 5 \times {K}_{2}$$

In these formulas, the unit of V₀₁, V₀₂ and V₀₃ is the μm, while the unit of V₁₁ is the μm². Therefore, the formula of K₁ can also be expressed: K₁=V₁₁−5.85 (μm)×V₀₁.

These profile parameters respect the following inequalities:

$$- 59 < {K}_{1} < - 47$$

$$18 < {K}_{2} < 24$$

$$- 133 < {K}_{3} < - 118$$

Thus, these profile parameters allow to better define the refractive-index profile of the optical fiber 1, and also allow to determine the limits of these profiles. Among the profiles defined by these profile parameters are angular profiles with a rectangular or trapezoidal shape, as illustrated by [FIG. 2], rounded profiles with a global rectangular or trapezoidal shape, as illustrated by [FIG. 3], and also profiles comprising a core with an inner central depressed zone 11 with either angular of rounded edges, as illustrated by [FIG. 4] and [FIG. 5].

Thus, as illustrated by [FIG. 3] the index profile of the core 10 can be rounded. In such a case, the first region of the core, with a radius r₀, ends exactly at the beginning of the refractive-index decrease, i.e. before the rounded part of the profile.

The cladding 20 of the optical fiber 1 can also present a profile with rounded edged. Such embodiment is not represented in the figures.

FIG. 4 represents another embodiment of the invention, in which the index profile of the core 10 comprises an inner central depressed zone 11, in the first region of the core. This figure represents an angular profile.

More particularly, as illustrated in [FIG. 4], this inner central depressed zone 11 extends from the center of the core (r=0) to a radius r₀, with r₀<r₀. In this inner central depressed zone 11, the refractive index n of the core, presents a minimum value at the center of the core equal to n_{0D}, with n_{0D}<n₀, or in other words, Δn_{0D}<Δn₀ with Δn_{0D}=n_{0D}−n₄.

FIG. 5 represents another embodiment of the invention, in which the index profile of the core (10) is rounded and comprises an inner central depressed zone (11). Thus, all the profile of the core (10), with the inner central depressed zone (11), can present rounded edges. In this case, the inner central depressed zone (11), with a radius r_{D}, ends when the maximum value (n₀, or Δn₀) of the core refractive index (n) is reached. In the embodiment represented in [FIG. 5], r_{D}=r₀ because the maximum value of n or Δn (which is n₀, or Δn₀) is only met at a unique point on the graph.

In an embodiment of the invention, the second region of the core from radius r₀ to radius r₁, with decrease of refractive index can be obtained by gradually changing a concentration of at least two dopants, which can be chosen among the following elements and/or molecules:
germanium oxide (GeO₂);
fluorine (F);
phosphorus oxide (P_{X}O_{Y});
boron oxide (B_{X}O_{Y});
aluminum oxide (Al₂O₃).

The modification of the refractive index of the other elements of the optical fiber 1 (other parts of the core 10, and the cladding 20) can also be obtained via a change in concentration of dopants in these different elements. More particularly, in an embodiment of the invention, the core 10 and the cladding 20 of the optical fiber 1 are both composed of silica, and the change in refractive index is obtained via the change in dopant concentration.

In a preferred embodiment, the impact of the inner central depressed zone 11 on V₁₁ should not induce a V₁₁ reduction of more than 1×10−3 μm², even more preferably 0.5×10−3 μm². [Table 2] below presents examples for an inner central depressed zone 11 presenting a fixed Δn_{0D}.

TABLE 2

| | |
|---|---|
| r_{D} = 1 μm | n_{0D} − n₀ ≥ − 1 × 10⁻³, |
| | and more preferably n_{0D} − n₀ ≥ − 0.5 × 10⁻³ |
| r_{D} = 0.5 μm | n_{0D} − n₀ ≥ − 4 × 10⁻³, |
| | and more preferably n_{0D} − n₀ ≥ − 2 × 10⁻³ |
| r_{D} = 0.25 μm | n_{0D} − n₀ ≥ − 16 × 10⁻³, |
| | and more preferably n_{0D} − n₀ ≥ − 8 × 10⁻³ |

The invention also relates to an optical fiber transmission system comprising an optical fiber 1 with the characteristics described previously. Preferentially, such system is a MDWDM system comprising a transmitter and a receiver, respectively comprising a multiplexer and a demultiplexer.

As an example, [FIG. 6] represents a MDWM system comprising an optical fiber 1, transmitters Tx, receivers

Rx, and optical multiplexers (OM) and demultiplexers (OD). The optical multiplexer and demultiplexer allow respectively to multiplex or concentrate several optical signals at one end of the system (λ₁, . . . λ_{N} and λ₁, . . . λ_{M}) and to demultiplex or separate these signals at the other end of the system, in one direction of in the other. Thus, the signal propagated in the single-mode optical fiber 1 of the invention is a multiplexed signal (a combination of several signals).

Optionally, such system can comprise repeaters (100-1, . . . , 100-n) if the system transmits over long distances. The repeaters can comprise one or more filters, and/or one or more amplifiers 101, and/or one or more dispersion compensating fibers 102, etc.

By using the optical fiber of the invention, the range of wavelength which can be used by the optical fiber transmission system is wider than the ones available for the optical communication system of the prior art. In fact, it can operate in the O- and E-wavelength bands (from 1268 to 1375 nm) using, for example, Metro Wave Division Multiplexing (MWDM) with a 25 Gb/s transceiver.

Furthermore, the Transmitter Dispersion Penalty of such an optical fiber transmission system is lower than 1.5 dB, or even lower than 0.5 dB.

Theoretical examples of parameters, which can be used for obtaining a single-mode optical fiber 1 according to the invention, are presented in the tables hereinafter. [Table 3] to [Table 14] present 94 examples of sets of parameters (Ex1 to Ex94).

More particularly, [Table 3] lists 30 examples (Ex1 to Ex30), each comprising different parameters of ratios (r₀/r₁), radiuses (r₀, r₁, r₂, r₃), and refractive-index differences with the third layer of cladding (Δn₀, Δn₂, Δn₃).

TABLE 3

| No | Ratio | r₀ | r₁ | r_{eq} | r₂ | r₃ | Δn₀ | Δn₂ | Δn₃ |
|---|---|---|---|---|---|---|---|---|---|
| (Units) | | (μm) | (μm) | (μm) | (μm) | (μm) | (×1000) | (×1000) | (×1000) |
| Ex1 | 0.05 | 0.185 | 3.7 | 1.9425 | 7.83 | 10.88 | 8.42 | 2.18 | −4.77 |
| Ex2 | 0.2 | 0.730 | 3.65 | 2.19 | 7.83 | 10.88 | 7.58 | 2.18 | −4.77 |
| Ex3 | 0.35 | 1.222 | 3.49 | 2.35575 | 7.83 | 10.88 | 7.04 | 2.2 | −4.77 |
| Ex4 | 0.5 | 1.635 | 3.27 | 2.4525 | 7.83 | 10.88 | 6.73 | 2.23 | −4.77 |
| Ex5 | 0.75 | 2.168 | 2.89 | 2.52875 | 7.83 | 10.88 | 6.49 | 2.25 | −4.77 |
| Ex6 | 0.95 | 2.480 | 2.61 | 2.54475 | 7.83 | 10.88 | 6.43 | 2.26 | −4.77 |
| Ex7 | 0.05 | 0.200 | 3.99 | 2.09475 | 8.27 | 10.88 | 8.18 | 1.94 | −6.27 |
| Ex8 | 0.2 | 0.784 | 3.92 | 2.352 | 8.27 | 10.88 | 7.35 | 1.95 | −6.27 |
| Ex9 | 0.35 | 1.309 | 3.74 | 2.5245 | 8.27 | 10.88 | 6.82 | 1.97 | −6.27 |
| Ex10 | 0.5 | 1.745 | 3.49 | 2.6175 | 8.27 | 10.88 | 6.51 | 2 | −6.27 |
| Ex11 | 0.75 | 2.303 | 3.07 | 2.68625 | 8.27 | 10.88 | 6.28 | 2.03 | −6.27 |
| Ex12 | 0.95 | 2.632 | 2.77 | 2.70075 | 8.27 | 10.88 | 6.23 | 2.03 | −6.27 |
| Ex13 | 0.05 | 0.212 | 4.24 | 2.226 | 8.7 | 10.88 | 8 | 1.72 | −8.39 |
| Ex14 | 0.2 | 0.832 | 4.16 | 2.496 | 8.7 | 10.88 | 7.17 | 1.74 | −8.39 |
| Ex15 | 0.35 | 1.383 | 3.95 | 2.66625 | 8.7 | 10.88 | 6.65 | 1.77 | −8.39 |
| Ex16 | 0.5 | 1.840 | 3.68 | 2.76 | 8.7 | 10.88 | 6.35 | 1.81 | −8.39 |
| Ex17 | 0.75 | 2.423 | 3.23 | 2.82625 | 8.7 | 10.88 | 6.13 | 1.83 | −8.39 |
| Ex18 | 0.95 | 2.765 | 2.91 | 2.83725 | 8.7 | 10.88 | 6.07 | 1.84 | −8.39 |
| Ex19 | 0.05 | 0.188 | 3.76 | 1.974 | 7.83 | 11.96 | 8.28 | 2.04 | −4.35 |
| Ex20 | 0.2 | 0.740 | 3.7 | 2.22 | 7.83 | 11.96 | 7.44 | 2.05 | −4.35 |
| Ex21 | 0.35 | 1.239 | 3.54 | 2.3895 | 7.83 | 11.96 | 6.91 | 2.07 | −4.35 |
| Ex22 | 0.5 | 1.655 | 3.31 | 2.4825 | 7.83 | 11.96 | 6.59 | 2.09 | −4.35 |
| Ex23 | 0.75 | 2.198 | 2.93 | 2.56375 | 7.83 | 11.96 | 6.34 | 2.11 | −4.35 |
| Ex24 | 0.95 | 2.508 | 2.64 | 2.574 | 7.83 | 11.96 | 6.29 | 2.11 | −4.35 |
| Ex25 | 0.05 | 0.201 | 4.01 | 2.10525 | 8.27 | 11.96 | 8.06 | 1.81 | −5.74 |
| Ex26 | 0.2 | 0.788 | 3.94 | 2.364 | 8.27 | 11.96 | 7.23 | 1.82 | −5.74 |
| Ex27 | 0.35 | 1.313 | 3.75 | 2.53125 | 8.27 | 11.96 | 6.7 | 1.85 | −5.74 |
| Ex28 | 0.5 | 1.755 | 3.51 | 2.6325 | 8.27 | 11.96 | 6.4 | 1.87 | −5.74 |
| Ex29 | 0.75 | 2.310 | 3.08 | 2.695 | 8.27 | 11.96 | 6.16 | 1.89 | −5.74 |
| Ex30 | 0.95 | 2.641 | 2.78 | 2.7105 | 8.27 | 11.96 | 6.11 | 1.9 | −5.74 |

[Table 4] refers to the same 30 examples of [Table 3] and represents the subsequent surface integrals and volume integrals of the core and layers of cladding (V₀₁, V₁₁, V₀₂, V₁₂, V₀₃, V₁₃). The profile parameters K₁, K₂ and K₃ are also listed in this table.

TABLE 4

| No | V₀₁ | V₁₁ | K₁ | V₀₂ | K₂ | V₁₂ | V₀₃ | V₁₃ | K₃ |
|---|---|---|---|---|---|---|---|---|---|
| (Units) | (μm) | (μm²) | (μm²) | (μm) | (μm) | (μm²) | (μm) | (μm²) | (μm) |
| Ex1 | 20.2 | 59.8 | −58.3 | 9.0 | 22.1 | 103.8 | −14.5 | −272.2 | −125.2 |
| Ex2 | 19.8 | 58.8 | −57.0 | 9.1 | 22.0 | 104.6 | −14.5 | −272.2 | −124.4 |
| Ex3 | 19.1 | 55.7 | −55.9 | 9.5 | 21.9 | 108.1 | −14.5 | −272.2 | −124.3 |
| Ex4 | 18.3 | 51.9 | −55.3 | 10.2 | 22.1 | 112.9 | −14.5 | −272.2 | −125.0 |
| Ex5 | 17.2 | 46.1 | −54.7 | 11.1 | 22.3 | 119.2 | −14.5 | −272.2 | −126.1 |
| Ex6 | 16.5 | 42.4 | −54.2 | 11.8 | 22.5 | 123.2 | −14.5 | −272.2 | −127.2 |
| Ex7 | 20.8 | 65.7 | −56.0 | 8.3 | 21.8 | 101.8 | −16.4 | −313.4 | −125.5 |
| Ex8 | 20.3 | 64.3 | −54.8 | 8.5 | 21.7 | 103.4 | −16.4 | −313.4 | −124.9 |
| Ex9 | 19.6 | 60.9 | −53.9 | 8.9 | 21.7 | 107.2 | −16.4 | −313.4 | −124.7 |
| Ex10 | 18.8 | 56.4 | −53.5 | 9.6 | 21.8 | 112.4 | −16.4 | −313.4 | −125.2 |
| Ex11 | 17.6 | 50.0 | −53.2 | 10.6 | 22.0 | 119.7 | −16.4 | −313.4 | −126.5 |
| Ex12 | 17.0 | 46.2 | −53.0 | 11.2 | 22.2 | 123.3 | −16.4 | −313.4 | −127.3 |
| Ex13 | 21.3 | 70.5 | −53.9 | 7.7 | 21.5 | 99.3 | −18.3 | −358.1 | −125.8 |
| Ex14 | 20.8 | 69.0 | −52.7 | 7.9 | 21.4 | 101.6 | −18.3 | −358.1 | −125.4 |
| Ex15 | 20.0 | 65.0 | −52.0 | 8.4 | 21.4 | 106.4 | −18.3 | −358.1 | −125.3 |
| Ex16 | 19.2 | 60.4 | −51.9 | 9.1 | 21.6 | 112.5 | −18.3 | −358.1 | −126.1 |
| Ex17 | 18.1 | 53.7 | −52.0 | 10.0 | 21.8 | 119.4 | −18.3 | −358.1 | −127.0 |
| Ex18 | 17.4 | 49.6 | −51.9 | 10.7 | 21.9 | 123.7 | −18.3 | −358.1 | −128.0 |
| Ex19 | 20.0 | 59.8 | −57.1 | 8.3 | 21.3 | 96.2 | −18.0 | −355.5 | −124.4 |
| Ex20 | 19.6 | 58.6 | −55.8 | 8.5 | 21.2 | 97.6 | −18.0 | −355.5 | −123.8 |
| Ex21 | 18.9 | 55.7 | −54.8 | 8.9 | 21.2 | 101.0 | −18.0 | −355.5 | −123.8 |
| Ex22 | 18.1 | 51.7 | −54.2 | 9.4 | 21.2 | 105.2 | −18.0 | −355.5 | −124.0 |
| Ex23 | 17.0 | 46.1 | −53.5 | 10.3 | 21.4 | 111.2 | −18.0 | −355.5 | −125.0 |
| Ex24 | 16.3 | 42.4 | −53.1 | 11.0 | 21.6 | 114.7 | −18.0 | −355.5 | −125.8 |
| Ex25 | 20.4 | 64.4 | −55.1 | 7.7 | 21.0 | 94.7 | −21.2 | −428.5 | −126.1 |
| Ex26 | 20.0 | 63.0 | −53.8 | 7.9 | 20.9 | 96.2 | −21.2 | −428.5 | −125.5 |
| Ex27 | 19.2 | 59.5 | −52.9 | 8.4 | 20.9 | 100.5 | −21.2 | −428.5 | −125.4 |
| Ex28 | 18.5 | 55.6 | −52.6 | 8.9 | 20.9 | 104.9 | −21.2 | −428.5 | −125.8 |
| Ex29 | 17.3 | 49.2 | −52.2 | 9.8 | 21.1 | 111.3 | −21.2 | −428.5 | −126.5 |
| Ex30 | 16.7 | 45.6 | −52.0 | 10.4 | 21.3 | 115.3 | −21.2 | −428.5 | −127.6 |

[Table 5] refers to the same 30 examples of [Table 3] and represents the corresponding Zero Dispersion Wavelength (ZDW), Zero Dispersion Shift (ZDS), Chromatic Dispersion (CD) at 1267.5 nm, at 1310 nm, and at 1374.5 nm, the Mode Filed Diameter (MFD) at 1310 nm and at 1550 nm, and the cable cutoff wavelength.

TABLE 5

| | | | CD | CD | CD | MFD | MFD | Cable |
|---|---|---|---|---|---|---|---|---|
| No | ZDW | ZDS | 1267.5 | 1310 | 1374.5 | 1310 | 1550 | Cutoff |
| (Units) | (nm) | (ps/(nm² · km)) | (ps/(nm · km)) | (ps/(nm · km)) | (ps/(nm · km)) | (μm) | (μm) | (nm) |
| Ex1 | 1350 | 0.097 | −8.9 | −4.1 | 2.4 | 9.00 | 10.33 | 1212 |
| Ex2 | 1350 | 0.096 | −8.9 | −4.1 | 2.4 | 9.00 | 10.33 | 1211 |
| Ex3 | 1350 | 0.096 | −8.8 | −4.1 | 2.3 | 9.00 | 10.33 | 1211 |
| Ex4 | 1350 | 0.096 | −8.8 | −4.1 | 2.4 | 9.00 | 10.34 | 1212 |
| Ex5 | 1350 | 0.096 | −8.8 | −4.1 | 2.3 | 9.00 | 10.33 | 1214 |
| Ex6 | 1350 | 0.096 | −8.7 | −4.1 | 2.4 | 9.00 | 10.34 | 1214 |
| Ex7 | 1350 | 0.096 | −8.8 | −4.1 | 2.4 | 9.00 | 10.34 | 1209 |
| Ex8 | 1350 | 0.096 | −8.8 | −4.1 | 2.3 | 9.00 | 10.34 | 1209 |
| Ex9 | 1350 | 0.096 | −8.8 | −4.1 | 2.3 | 9.00 | 10.34 | 1209 |
| Ex10 | 1350 | 0.095 | −8.7 | −4.1 | 2.3 | 9.00 | 10.35 | 1210 |
| Ex11 | 1350 | 0.095 | −8.7 | −4 | 2.3 | 9.01 | 10.35 | 1210 |
| Ex12 | 1350 | 0.095 | −8.7 | −4.1 | 2.3 | 9.00 | 10.35 | 1210 |
| Ex13 | 1350 | 0.095 | −8.7 | −4.1 | 2.3 | 9.00 | 10.34 | 1209 |
| Ex14 | 1350 | 0.095 | −8.7 | −4.1 | 2.3 | 9.00 | 10.34 | 1209 |
| Ex15 | 1350 | 0.095 | −8.7 | −4 | 2.3 | 9.00 | 10.34 | 1209 |
| Ex16 | 1350 | 0.095 | −8.6 | −4 | 2.3 | 9.01 | 10.35 | 1209 |
| Ex17 | 1350 | 0.094 | −8.6 | −4 | 2.3 | 8.99 | 10.34 | 1209 |
| Ex18 | 1350 | 0.094 | −8.6 | −4 | 2.3 | 9.00 | 10.35 | 1209 |
| Ex19 | 1350 | 0.097 | −8.9 | −4.1 | 2.4 | 9.00 | 10.33 | 1210 |
| Ex20 | 1350 | 0.097 | −8.8 | −4.1 | 2.4 | 9.00 | 10.34 | 1210 |
| Ex21 | 1350 | 0.096 | −8.8 | −4.1 | 2.3 | 8.99 | 10.33 | 1210 |
| Ex22 | 1350 | 0.096 | −8.8 | −4.1 | 2.4 | 9.00 | 10.34 | 1210 |
| Ex23 | 1350 | 0.096 | −8.7 | −4 | 2.4 | 9.00 | 10.34 | 1208 |
| Ex24 | 1350 | 0.096 | −8.8 | −4.1 | 2.3 | 9.00 | 10.34 | 1209 |
| Ex25 | 1350 | 0.097 | −8.8 | −4.1 | 2.4 | 9.00 | 10.34 | 1213 |
| Ex26 | 1350 | 0.096 | −8.8 | −4.1 | 2.4 | 9.00 | 10.34 | 1212 |
| Ex27 | 1350 | 0.096 | −8.8 | −4.1 | 2.4 | 9.01 | 10.34 | 1213 |
| Ex28 | 1350 | 0.096 | −8.7 | −4.1 | 2.3 | 9.00 | 10.33 | 1213 |
| Ex29 | 1350 | 0.096 | −8.7 | −4.1 | 2.3 | 9.00 | 10.34 | 1212 |
| Ex30 | 1350 | 0.095 | −8.7 | −4.1 | 2.3 | 9.00 | 10.34 | 1212 |

[Table 6] refers to the same 30 examples of [Table 3] and represents the corresponding bend losses (R7.5BL, R10BL and R15BL) for either 1 or 10 turns, measured at different wavelengths (1550 μm and 1625 μm), and for different radiuses (7.5 mm, 10 mm, and 15 mm).

TABLE 6

| | R15BL | R10BL | R7.5BL | R15BL | R10BL | R7.5BL | |
|---|---|---|---|---|---|---|---|
| No | at 1550 | at 1550 | at 1550 | at 1625 | at 1625 | at 1625 | |
| (Units) | (dB/10turn) | (dB/turn) | (dB/turn) | (dB/10turn) | (dB/turn) | (dB/turn) | BL Type |
| Ex1 | 0.034 | 0.16 | 0.92 | 0.184 | 0.47 | 1.94 | A1 |
| Ex2 | 0.035 | 0.16 | 0.93 | 0.189 | 0.48 | 1.96 | A1 |
| Ex3 | 0.035 | 0.17 | 0.94 | 0.191 | 0.48 | 1.97 | A1 |
| Ex4 | 0.036 | 0.17 | 0.95 | 0.194 | 0.49 | 1.99 | A1 |
| Ex5 | 0.035 | 0.17 | 0.95 | 0.192 | 0.48 | 1.99 | A1 |
| Ex6 | 0.036 | 0.17 | 0.95 | 0.193 | 0.49 | 2 | A1 |
| Ex7 | 0.035 | 0.16 | 0.84 | 0.189 | 0.45 | 1.75 | A1 |
| Ex8 | 0.036 | 0.16 | 0.85 | 0.191 | 0.45 | 1.76 | A1 |
| Ex9 | 0.037 | 0.16 | 0.86 | 0.196 | 0.46 | 1.79 | A1 |
| Ex10 | 0.037 | 0.16 | 0.87 | 0.198 | 0.46 | 1.81 | A1 |
| Ex11 | 0.039 | 0.17 | 0.9 | 0.207 | 0.48 | 1.85 | A1 |
| Ex12 | 0.04 | 0.17 | 0.9 | 0.21 | 0.48 | 1.86 | A1 |
| Ex13 | 0.035 | 0.14 | 0.75 | 0.184 | 0.41 | 1.56 | A1 |
| Ex14 | 0.036 | 0.15 | 0.76 | 0.188 | 0.42 | 1.57 | A1 |
| Ex15 | 0.037 | 0.15 | 0.78 | 0.192 | 0.42 | 1.6 | A1 |
| Ex16 | 0.038 | 0.15 | 0.8 | 0.199 | 0.43 | 1.63 | A1 |
| Ex17 | 0.041 | 0.16 | 0.83 | 0.213 | 0.45 | 1.69 | A1 |
| Ex18 | 0.042 | 0.16 | 0.84 | 0.217 | 0.46 | 1.71 | A1 |
| Ex19 | 0.043 | 0.15 | 0.7 | 0.218 | 0.41 | 1.42 | A1 |
| Ex20 | 0.042 | 0.15 | 0.7 | 0.217 | 0.41 | 1.42 | A1 |
| Ex21 | 0.043 | 0.15 | 0.7 | 0.219 | 0.41 | 1.43 | A1 |
| Ex22 | 0.045 | 0.15 | 0.72 | 0.228 | 0.42 | 1.46 | A1 |
| Ex23 | 0.048 | 0.16 | 0.75 | 0.244 | 0.44 | 1.52 | A1 |
| Ex24 | 0.048 | 0.16 | 0.75 | 0.245 | 0.44 | 1.51 | A1 |
| Ex25 | 0.043 | 0.13 | 0.57 | 0.213 | 0.35 | 1.15 | A1 |
| Ex26 | 0.043 | 0.13 | 0.58 | 0.217 | 0.36 | 1.16 | A1 |
| Ex27 | 0.043 | 0.13 | 0.58 | 0.217 | 0.36 | 1.17 | A1 |
| Ex28 | 0.045 | 0.13 | 0.59 | 0.223 | 0.37 | 1.19 | A1 |
| Ex29 | 0.049 | 0.14 | 0.62 | 0.241 | 0.38 | 1.24 | A1 |
| Ex30 | 0.05 | 0.14 | 0.63 | 0.247 | 0.39 | 1.25 | A1 |

[Table 7], [Table 8] and [Table 9] represent 30 more examples (Ex31 to Ex60), listing the same parameters as respectively [Table 3], [Table 4], [Table 5] and [Table 6].

TABLE 7

| No | | r₀ | r₁ | r_{eq} | r₂ | r₃ | Δn₀ | Δn₂ | Δn₃ |
|---|---|---|---|---|---|---|---|---|---|
| (Units) | Ratio | (μm) | (μm) | (μm) | (μm) | (μm) | (×1000) | (×1000) | (×1000) |
| Ex31 | 0.05 | 0.212 | 4.24 | 2.226 | 8.7 | 11.96 | 7.89 | 1.59 | −7.58 |
| Ex32 | 0.2 | 0.832 | 4.16 | 2.496 | 8.7 | 11.96 | 7.05 | 1.6 | −7.58 |
| Ex33 | 0.35 | 1.383 | 3.95 | 2.66625 | 8.7 | 11.96 | 6.54 | 1.65 | −7.58 |
| Ex34 | 0.5 | 1.840 | 3.68 | 2.76 | 8.7 | 11.96 | 6.24 | 1.68 | −7.58 |
| Ex35 | 0.75 | 2.423 | 3.23 | 2.82625 | 8.7 | 11.96 | 6 | 1.7 | −7.58 |
| Ex36 | 0.95 | 2.765 | 2.91 | 2.83725 | 8.7 | 11.96 | 5.95 | 1.7 | −7.58 |
| Ex37 | 0.05 | 0.194 | 3.87 | 2.03175 | 7.83 | 13.05 | 8.11 | 1.9 | −3.95 |
| Ex38 | 0.2 | 0.762 | 3.81 | 2.286 | 7.83 | 13.05 | 7.27 | 1.9 | −3.95 |
| Ex39 | 0.35 | 1.274 | 3.64 | 2.457 | 7.83 | 13.05 | 6.76 | 1.94 | −3.95 |
| Ex40 | 0.5 | 1.700 | 3.4 | 2.55 | 7.83 | 13.05 | 6.45 | 1.97 | −3.95 |
| Ex41 | 0.75 | 2.250 | 3 | 2.625 | 7.83 | 13.05 | 6.21 | 1.98 | −3.95 |
| Ex42 | 0.95 | 2.575 | 2.71 | 2.64225 | 7.83 | 13.05 | 6.15 | 1.99 | −3.95 |
| Ex43 | 0.05 | 0.204 | 4.08 | 2.142 | 8.27 | 13.05 | 7.95 | 1.7 | −5.25 |
| Ex44 | 0.2 | 0.804 | 4.02 | 2.412 | 8.27 | 13.05 | 7.12 | 1.71 | −5.25 |
| Ex45 | 0.35 | 1.337 | 3.82 | 2.5785 | 8.27 | 13.05 | 6.6 | 1.74 | −5.25 |
| Ex46 | 0.5 | 1.780 | 3.56 | 2.67 | 8.27 | 13.05 | 6.29 | 1.77 | −5.25 |
| Ex47 | 0.75 | 2.348 | 3.13 | 2.73875 | 8.27 | 13.05 | 6.06 | 1.79 | −5.25 |
| Ex48 | 0.95 | 2.689 | 2.83 | 2.75925 | 8.27 | 13.05 | 6 | 1.79 | −5.25 |
| Ex49 | 0.05 | 0.215 | 4.3 | 2.2575 | 8.7 | 13.05 | 7.78 | 1.48 | −6.9 |
| Ex50 | 0.2 | 0.844 | 4.22 | 2.532 | 8.7 | 13.05 | 6.95 | 1.5 | −6.9 |
| Ex51 | 0.35 | 1.400 | 4 | 2.7 | 8.7 | 13.05 | 6.44 | 1.54 | −6.9 |
| Ex52 | 0.5 | 1.860 | 3.72 | 2.79 | 8.7 | 13.05 | 6.14 | 1.57 | −6.9 |
| Ex53 | 0.75 | 2.445 | 3.26 | 2.8525 | 8.7 | 13.05 | 5.91 | 1.6 | −6.9 |
| Ex54 | 0.95 | 2.793 | 2.94 | 2.8665 | 8.7 | 13.05 | 5.86 | 1.61 | −6.9 |
| Ex55 | 0.45 | 1.481 | 3.29 | 2.38525 | 8.27 | 13.05 | 6.54 | 1.95 | −5.25 |
| Ex56 | 0.25 | 0.908 | 3.63 | 2.26875 | 8.27 | 13.05 | 7.18 | 1.86 | −5.25 |
| Ex57 | 0.4 | 1.352 | 3.38 | 2.366 | 7.83 | 13.05 | 6.54 | 1.93 | −3.95 |
| Ex58 | 0.7 | 2.072 | 2.96 | 2.516 | 7.83 | 11.96 | 6.55 | 2.28 | −4.35 |
| Ex59 | 0.15 | 0.593 | 3.95 | 2.27125 | 8.27 | 10.88 | 7.73 | 2.05 | −6.27 |
| Ex60 | 0.1 | 0.390 | 3.9 | 2.145 | 7.83 | 10.88 | 7.92 | 2.19 | −4.77 |

TABLE 8

| No | V₀₁ | V₁₁ | K₁ | V₀₂ | K₂ | V₁₂ | V₀₃ | V₁₃ | K₃ |
|---|---|---|---|---|---|---|---|---|---|
| (Units) | (μm) | (μm²) | (μm²) | (μm) | (μm) | (μm²) | (μm) | (μm²) | (μm) |
| Ex31 | 20.8 | 68.3 | −53.2 | 7.1 | 20.6 | 91.8 | −24.7 | −510.5 | −127.7 |
| Ex32 | 20.3 | 66.7 | −51.8 | 7.3 | 20.4 | 93.4 | −24.7 | −510.5 | −126.9 |
| Ex33 | 19.6 | 63.2 | −51.2 | 7.8 | 20.5 | 99.1 | −24.7 | −510.5 | −127.5 |
| Ex34 | 18.8 | 58.8 | −51.0 | 8.4 | 20.6 | 104.4 | −24.7 | −510.5 | −127.9 |
| Ex35 | 17.6 | 52.3 | −50.9 | 9.3 | 20.8 | 110.9 | −24.7 | −510.5 | −128.5 |
| Ex36 | 17.0 | 48.6 | −50.9 | 9.8 | 20.9 | 114.3 | −24.7 | −510.5 | −129.2 |
| Ex37 | 20.0 | 61.1 | −55.7 | 7.5 | 20.5 | 88.0 | −20.6 | −430.5 | −123.1 |
| Ex38 | 19.5 | 59.8 | −54.4 | 7.6 | 20.3 | 88.9 | −20.6 | −430.5 | −122.2 |
| Ex39 | 18.9 | 57.1 | −53.5 | 8.1 | 20.4 | 93.2 | −20.6 | −430.5 | −122.7 |
| Ex40 | 18.1 | 53.0 | −53.0 | 8.7 | 20.5 | 98.0 | −20.6 | −430.5 | −123.2 |
| Ex41 | 17.0 | 47.2 | −52.5 | 9.6 | 20.6 | 103.6 | −20.6 | −430.5 | −123.8 |
| Ex42 | 16.4 | 43.7 | −52.2 | 10.2 | 20.8 | 107.4 | −20.6 | −430.5 | −124.8 |
| Ex43 | 20.3 | 64.8 | −54.1 | 7.1 | 20.3 | 88.0 | −25.1 | −535.0 | −126.8 |
| Ex44 | 19.9 | 63.8 | −52.8 | 7.3 | 20.2 | 89.3 | −25.1 | −535.0 | −126.2 |
| Ex45 | 19.2 | 60.2 | −52.0 | 7.7 | 20.2 | 93.6 | −25.1 | −535.0 | −126.1 |
| Ex46 | 18.4 | 55.8 | −51.6 | 8.3 | 20.3 | 98.6 | −25.1 | −535.0 | −126.5 |
| Ex47 | 17.3 | 49.8 | −51.4 | 9.2 | 20.4 | 104.9 | −25.1 | −535.0 | −127.3 |
| Ex48 | 16.7 | 46.4 | −51.2 | 9.7 | 20.6 | 108.1 | −25.1 | −535.0 | −128.0 |
| Ex49 | 20.6 | 68.2 | −52.2 | 6.5 | 19.9 | 84.7 | −30.0 | −652.8 | −129.5 |
| Ex50 | 20.1 | 66.8 | −50.9 | 6.7 | 19.8 | 86.8 | −30.0 | −652.8 | −129.0 |
| Ex51 | 19.4 | 63.1 | −50.3 | 7.2 | 19.8 | 91.9 | −30.0 | −652.8 | −129.2 |
| Ex52 | 18.6 | 58.6 | −50.1 | 7.8 | 19.9 | 97.1 | −30.0 | −652.8 | −129.5 |
| Ex53 | 17.5 | 52.3 | −50.1 | 8.7 | 20.1 | 104.1 | −30.0 | −652.8 | −130.4 |
| Ex54 | 16.9 | 48.8 | −50.1 | 9.3 | 20.3 | 107.9 | −30.0 | −652.8 | −131.4 |
| Ex55 | 17.4 | 48.5 | −53.1 | 9.7 | 21.0 | 112.3 | −25.1 | −535.0 | −130.1 |
| Ex56 | 18.8 | 55.2 | −54.9 | 8.6 | 20.9 | 102.7 | −25.1 | −535.0 | −129.4 |
| Ex57 | 17.4 | 49.4 | −52.5 | 8.6 | 19.9 | 96.3 | −20.6 | −430.5 | −120.2 |
| Ex58 | 17.5 | 47.3 | −55.0 | 11.1 | 22.5 | 119.8 | −18.0 | −355.5 | −130.3 |
| Ex59 | 21.0 | 66.6 | −56.2 | 8.9 | 22.5 | 108.2 | −16.4 | −313.4 | −128.9 |
| Ex60 | 20.8 | 65.6 | −56.3 | 8.6 | 22.1 | 101.0 | −14.5 | −272.2 | −125.3 |

TABLE 9

| | | | CD | CD | CD | MFD | MFD | Cable |
|---|---|---|---|---|---|---|---|---|
| No | ZDW | ZDS | 1267.5 | 1310 | 1374.5 | 1310 | 1550 | Cutoff |
| (Units) | (nm) | (ps/(nm² · km)) | (ps/(nm · km)) | (ps/(nm · km)) | (ps/(nm · km)) | (μm) | (μm) | (nm) |
| Ex31 | 1350 | 0.096 | −8.8 | −4.1 | 2.3 | 8.99 | 10.33 | 1216 |
| Ex32 | 1350 | 0.096 | −8.7 | −4.1 | 2.3 | 9.00 | 10.33 | 1215 |
| Ex33 | 1350 | 0.096 | −8.7 | −4 | 2.3 | 9.00 | 10.34 | 1219 |
| Ex34 | 1350 | 0.095 | −8.6 | −4 | 2.3 | 9.00 | 10.34 | 1218 |
| Ex35 | 1350 | 0.095 | −8.6 | −4 | 2.3 | 9.00 | 10.35 | 1215 |
| Ex36 | 1350 | 0.095 | −8.6 | −4 | 2.3 | 9.00 | 10.34 | 1215 |
| Ex37 | 1350 | 0.096 | −8.8 | −4.1 | 2.4 | 9.00 | 10.34 | 1214 |
| Ex38 | 1350 | 0.096 | −8.8 | −4.1 | 2.4 | 9.00 | 10.34 | 1213 |
| Ex39 | 1350 | 0.096 | −8.8 | −4.1 | 2.3 | 9.00 | 10.34 | 1218 |
| Ex40 | 1350 | 0.096 | −8.7 | −4 | 2.4 | 9.00 | 10.35 | 1219 |
| Ex41 | 1350 | 0.095 | −8.7 | −4 | 2.3 | 9.00 | 10.34 | 1217 |
| Ex42 | 1350 | 0.095 | −8.7 | −4 | 2.4 | 9.00 | 10.35 | 1216 |
| Ex43 | 1350 | 0.096 | −8.8 | −4.1 | 2.3 | 9.00 | 10.34 | 1214 |
| Ex44 | 1350 | 0.096 | −8.8 | −4.1 | 2.3 | 9.00 | 10.34 | 1215 |
| Ex45 | 1350 | 0.096 | −8.7 | −4.1 | 2.3 | 9.00 | 10.34 | 1218 |
| Ex46 | 1350 | 0.095 | −8.7 | −4 | 2.3 | 9.01 | 10.35 | 1213 |
| Ex47 | 1350 | 0.095 | −8.7 | −4 | 2.3 | 9.00 | 10.35 | 1214 |
| Ex48 | 1350 | 0.095 | −8.6 | −4 | 2.3 | 9.00 | 10.34 | 1214 |
| Ex49 | 1350 | 0.096 | −8.7 | −4.1 | 2.3 | 9.00 | 10.34 | 1205 |
| Ex50 | 1350 | 0.096 | −8.7 | −4 | 2.3 | 9.00 | 10.34 | 1205 |
| Ex51 | 1350 | 0.095 | −8.7 | −4 | 2.3 | 9.00 | 10.34 | 1207 |
| Ex52 | 1350 | 0.095 | −8.6 | −4 | 2.3 | 9.00 | 10.34 | 1206 |
| Ex53 | 1350 | 0.095 | −8.6 | −4 | 2.3 | 9.00 | 10.35 | 1206 |
| Ex54 | 1350 | 0.095 | −8.6 | −4 | 2.3 | 9.00 | 10.35 | 1206 |
| Ex55 | 1352 | 0.098 | −9.3 | −4.4 | 2.2 | 9.18 | 10.58 | 1221 |
| Ex56 | 1356 | 0.097 | −9.5 | −4.7 | 1.8 | 9.03 | 10.43 | 1215 |
| Ex57 | 1350 | 0.097 | −8.8 | −4.1 | 2.4 | 9.15 | 10.52 | 1186 |
| Ex58 | 1350 | 0.096 | −8.8 | −4.1 | 2.4 | 9.01 | 10.35 | 1245 |
| Ex59 | 1351 | 0.096 | −8.9 | −4.2 | 2.3 | 8.98 | 10.31 | 1237 |
| Ex60 | 1345 | 0.096 | −8.3 | −3.6 | 2.8 | 9.04 | 10.33 | 1229 |

TABLE 10

| | R15BL | R10BL | R7.5BL | R15BL | R10BL | R7.5BL | |
|---|---|---|---|---|---|---|---|
| No | at 1550 | at 1550 | at 1550 | at 1625 | at 1625 | at 1625 | |
| (Units) | (dB/10turn) | (dB/turn) | (dB/turn) | (dB/10turn) | (dB/turn) | (dB/turn) | BL Type |
| Ex31 | 0.04 | 0.11 | 0.46 | 0.197 | 0.29 | 0.91 | A1 |
| Ex32 | 0.041 | 0.11 | 0.46 | 0.203 | 0.3 | 0.93 | A1 |
| Ex33 | 0.039 | 0.11 | 0.46 | 0.194 | 0.29 | 0.92 | A1 |
| Ex34 | 0.043 | 0.11 | 0.48 | 0.21 | 0.31 | 0.95 | A1 |
| Ex35 | 0.048 | 0.12 | 0.5 | 0.232 | 0.33 | 1 | A1 |
| Ex36 | 0.049 | 0.12 | 0.51 | 0.236 | 0.33 | 1.01 | A1 |
| Ex37 | 0.046 | 0.12 | 0.51 | 0.224 | 0.33 | 1.02 | A1 |
| Ex38 | 0.047 | 0.12 | 0.51 | 0.229 | 0.33 | 1.03 | A1 |
| Ex39 | 0.043 | 0.12 | 0.5 | 0.213 | 0.32 | 1.01 | A1 |
| Ex40 | 0.044 | 0.12 | 0.51 | 0.219 | 0.33 | 1.02 | A1 |
| Ex41 | 0.048 | 0.13 | 0.52 | 0.236 | 0.34 | 1.05 | A1 |
| Ex42 | 0.049 | 0.13 | 0.53 | 0.241 | 0.35 | 1.07 | A1 |
| Ex43 | 0.036 | 0.09 | 0.34 | 0.177 | 0.24 | 0.69 | A1 |
| Ex44 | 0.036 | 0.09 | 0.34 | 0.177 | 0.24 | 0.69 | A1 |
| Ex45 | 0.037 | 0.09 | 0.35 | 0.18 | 0.24 | 0.7 | A1 |
| Ex46 | 0.04 | 0.09 | 0.36 | 0.192 | 0.25 | 0.72 | A1 |
| Ex47 | 0.042 | 0.1 | 0.37 | 0.202 | 0.26 | 0.74 | A1 |
| Ex48 | 0.043 | 0.1 | 0.37 | 0.206 | 0.26 | 0.74 | A1 |
| Ex49 | 0.031 | 0.07 | 0.24 | 0.151 | 0.18 | 0.48 | A1 |
| Ex50 | 0.031 | 0.07 | 0.24 | 0.151 | 0.18 | 0.48 | A1 |
| Ex51 | 0.032 | 0.07 | 0.24 | 0.152 | 0.18 | 0.49 | A1 |
| Ex52 | 0.034 | 0.07 | 0.25 | 0.163 | 0.19 | 0.51 | A1 |
| Ex53 | 0.037 | 0.07 | 0.26 | 0.173 | 0.19 | 0.52 | A1 |
| Ex54 | 0.037 | 0.07 | 0.26 | 0.176 | 0.19 | 0.52 | A1 |
| Ex55 | 0.071 | 0.13 | 0.48 | 0.310 | 0.34 | 0.92 | A1 |
| Ex56 | 0.052 | 0.11 | 0.42 | 0.241 | 0.29 | 0.82 | A1 |
| Ex57 | 0.150 | 0.24 | 0.83 | 0.636 | 0.59 | 1.57 | A1 |
| Ex58 | 0.018 | 0.09 | 0.51 | 0.101 | 0.27 | 1.09 | A1 |
| Ex59 | 0.015 | 0.09 | 0.60 | 0.089 | 0.28 | 1.31 | A1 |
| Ex60 | 0.018 | 0.11 | 0.71 | 0.106 | 0.33 | 1.55 | A1 |

Finally, [Table 11], [Table 12], [Table 13] and [Table 14] represent 34 more examples (Ex61 to Ex94), listing the same parameters as respectively [Table 3], [Table 4], [Table 5] and [Table 6].

TABLE 11

| No | | r₀ | r₁ | r_{eq} | r₂ | r₃ | Δn₀ | Δn₂ | Δn₃ |
|---|---|---|---|---|---|---|---|---|---|
| (Units) | Ratio | (μm) | (μm) | (μm) | (μm) | (μm) | (×1000) | (×1000) | (×1000) |
| Ex61 | 0.5 | 1.610 | 3.22 | 2.415 | 7.83 | 10.88 | 7.04 | 2.38 | −4.77 |
| Ex62 | 0.3 | 1.062 | 3.54 | 2.301 | 8.27 | 11.96 | 7.04 | 2.09 | −5.74 |
| Ex63 | 0.6 | 1.938 | 3.23 | 2.584 | 7.83 | 10.88 | 6.47 | 1.99 | −4.77 |
| Ex64 | 0.3 | 1.236 | 4.12 | 2.678 | 8.27 | 10.88 | 6.9 | 1.76 | −6.27 |
| Ex65 | 0.25 | 0.785 | 3.14 | 1.9625 | 7.83 | 10.88 | 7.66 | 2.33 | −4.77 |
| Ex66 | 0.1 | 0.407 | 4.07 | 2.2385 | 7.83 | 10.88 | 7.72 | 2.05 | −4.77 |
| Ex67 | 0.25 | 0.928 | 3.71 | 2.31875 | 7.83 | 10.88 | 7.25 | 2.39 | −4.77 |
| Ex68 | 0.95 | 2.584 | 2.72 | 2.652 | 7.83 | 10.88 | 6.18 | 2.28 | −4.77 |
| Ex69 | 0.7 | 2.289 | 3.27 | 2.7795 | 8.7 | 10.88 | 6.27 | 1.98 | −8.39 |
| Ex70 | 0.7 | 2.156 | 3.08 | 2.618 | 7.83 | 13.05 | 6.58 | 2.16 | −3.95 |
| Ex71 | 0.1 | 0.506 | 5.06 | 2.783 | 8.27 | 13.05 | 7.74 | 1.18 | −5.25 |
| Ex72 | 0.2 | 0.828 | 4.14 | 2.484 | 7.83 | 11.96 | 7.43 | 1.94 | −4.35 |
| Ex73 | 0.3 | 1.332 | 4.44 | 2.886 | 8.27 | 13.05 | 6.39 | 1.43 | −5.25 |
| Ex74 | 0.1 | 0.441 | 4.41 | 2.4255 | 8.7 | 13.05 | 7.39 | 1.6 | −6.9 |
| Ex75 | 0.4 | 1.652 | 4.13 | 2.891 | 8.7 | 13.05 | 6.48 | 1.21 | −6.9 |
| Ex76 | 0.5 | 1.720 | 3.44 | 2.58 | 7.83 | 13.05 | 6.39 | 2.17 | −3.95 |
| Ex77 | 0.1 | 0.480 | 4.8 | 2.64 | 8.27 | 10.88 | 7.86 | 1.66 | −6.27 |
| Ex78 | 0.6 | 2.292 | 3.82 | 3.056 | 7.83 | 11.96 | 6.54 | 1.87 | −4.35 |
| Ex79 | 0.9 | 2.763 | 3.07 | 2.9165 | 8.27 | 10.88 | 6.21 | 2.13 | −6.27 |
| Ex80 | 0.4 | 1.612 | 4.03 | 2.821 | 8.27 | 11.96 | 6.44 | 1.82 | −5.74 |
| Ex81 | 0.45 | 1.899 | 4.22 | 3.0595 | 8.27 | 13.05 | 6.17 | 1.4 | −5.25 |
| Ex82 | 0.4 | 1.664 | 4.16 | 2.912 | 8.27 | 13.05 | 6.55 | 1.34 | −5.25 |
| Ex83 | 0.3 | 1.305 | 4.35 | 2.8275 | 8.7 | 11.96 | 6.54 | 1.65 | −7.58 |
| Ex84 | 0.6 | 2.394 | 3.99 | 3.192 | 8.7 | 11.96 | 6.15 | 1.44 | −7.58 |
| Ex85 | 0.7 | 2.345 | 3.35 | 2.8475 | 8.7 | 11.96 | 6.42 | 1.6 | −7.58 |
| Ex86 | 0.1 | 0.434 | 4.34 | 2.387 | 7.83 | 13.05 | 8.16 | 1.76 | −3.95 |
| Ex87 | 0.85 | 2.992 | 3.52 | 3.256 | 8.7 | 13.05 | 5.99 | 1.23 | −6.9 |
| Ex88 | 0.1 | 0.448 | 4.48 | 2.464 | 8.7 | 10.88 | 7.93 | 1.74 | −8.39 |
| Ex89 | 0.25 | 1.150 | 4.6 | 2.875 | 8.27 | 10.88 | 7.11 | 1.74 | −6.27 |
| Ex90 | 0.2 | 0.894 | 4.47 | 2.682 | 7.83 | 11.96 | 7.15 | 1.74 | −4.35 |
| Ex91 | 0.45 | 1.733 | 3.85 | 2.79125 | 8.7 | 11.96 | 6.75 | 1.57 | −7.58 |
| Ex92 | 0.9 | 2.790 | 3.1 | 2.945 | 8.27 | 13.05 | 6.09 | 1.69 | −5.25 |
| Ex93 | 0.75 | 2.790 | 3.72 | 3.255 | 8.7 | 11.96 | 6.26 | 1.44 | −7.58 |
| Ex94 | 0.25 | 1.070 | 4.28 | 2.675 | 7.83 | 10.88 | 7.53 | 2.04 | −4′.77 |

TABLE 12

| No | V₀₁ | V₁₁ | K₁ | V₀₂ | K₂ | V₁₂ | V₀₃ | V₁₃ | K₃ |
|---|---|---|---|---|---|---|---|---|---|
| (Units) | (μm) | (μm²) | (μm²) | (μm) | (μm) | (μm²) | (μm) | (μm²) | (μm) |
| Ex61 | 18.9 | 52.9 | −57.8 | 11.0 | 23.3 | 121.2 | −14.5 | −272.2 | −130.9 |
| Ex62 | 18.8 | 54.9 | −55.0 | 9.9 | 22.1 | 116.8 | −21.2 | −428.5 | −131.7 |
| Ex63 | 18.0 | 51.3 | −54.0 | 9.2 | 20.9 | 101.2 | −14.5 | −272.2 | −118.8 |
| Ex64 | 21.0 | 70.3 | −52.6 | 7.3 | 21.0 | 90.5 | −16.4 | −313.4 | −121.2 |
| Ex65 | 17.8 | 46.0 | −58.0 | 10.9 | 22.5 | 119.9 | −14.5 | −272.2 | −127.0 |
| Ex66 | 21.0 | 68.7 | −54.3 | 7.7 | 21.4 | 91.7 | −14.5 | −272.2 | −121.5 |
| Ex67 | 20.1 | 62.2 | −55.6 | 9.8 | 22.9 | 113.6 | −14.5 | −272.2 | −129.2 |
| Ex68 | 16.5 | 44.3 | −52.5 | 11.7 | 22.4 | 122.9 | −14.5 | −272.2 | −126.6 |
| Ex69 | 18.4 | 54.7 | −53.0 | 10.8 | 22.7 | 128.7 | −18.3 | −358.1 | −131.8 |
| Ex70 | 18.2 | 51.1 | −55.5 | 10.3 | 22.1 | 111.9 | −20.6 | −430.5 | −131.1 |
| Ex71 | 24.2 | 92.4 | −49.4 | 3.8 | 19.5 | 50.5 | −25.1 | −535.0 | −122.8 |
| Ex72 | 21.7 | 72.1 | −54.6 | 7.2 | 21.2 | 85.7 | −18.0 | −355.5 | −124.2 |
| Ex73 | 20.7 | 73.5 | −47.4 | 5.5 | 18.9 | 69.6 | −25.1 | −535.0 | −119.6 |
| Ex74 | 21.1 | 72.8 | −50.7 | 6.9 | 20.6 | 90.0 | −30.0 | −652.8 | −132.9 |
| Ex75 | 20.2 | 67.4 | −51.0 | 5.5 | 18.7 | 70.9 | −30.0 | −652.8 | −123.4 |
| Ex76 | 18.4 | 54.8 | −52.6 | 9.5 | 21.5 | 107.4 | −20.6 | −430.5 | −127.9 |
| Ex77 | 24.3 | 91.1 | −51.3 | 5.8 | 21.6 | 75.3 | −16.4 | −313.4 | −124.3 |
| Ex78 | 21.4 | 71.8 | −53.5 | 7.5 | 21.4 | 87.4 | −18.0 | −355.5 | −125.1 |
| Ex79 | 18.4 | 54.8 | −53.1 | 11.1 | 23.1 | 125.6 | −16.4 | −313.4 | −131.7 |
| Ex80 | 20.4 | 68.6 | −50.6 | 7.7 | 21.0 | 94.9 | −21.2 | −428.5 | −126.0 |
| Ex81 | 20.5 | 71.7 | −48.2 | 5.7 | 19.0 | 70.8 | −25.1 | −535.0 | −120.1 |
| Ex82 | 20.7 | 70.1 | −51.3 | 5.5 | 19.0 | 68.5 | −25.1 | −535.0 | −120.1 |
| Ex83 | 21.0 | 74.1 | −48.8 | 7.2 | 20.8 | 93.7 | −24.7 | −510.5 | −128.9 |
| Ex84 | 20.8 | 71.9 | −49.6 | 6.8 | 20.3 | 86.1 | −24.7 | −510.5 | −126.2 |
| Ex85 | 19.1 | 57.4 | −54.2 | 8.6 | 21.0 | 103.1 | −24.7 | −510.5 | −129.5 |
| Ex86 | 22.9 | 77.8 | −56.3 | 6.1 | 21.0 | 74.8 | −20.6 | −430.5 | −125.8 |
| Ex87 | 19.8 | 65.8 | −50.2 | 6.4 | 19.3 | 77.9 | −30.0 | −652.8 | −126.3 |
| Ex88 | 23.0 | 80.9 | −53.9 | 7.3 | 22.3 | 96.8 | −18.3 | −358.1 | −129.9 |
| Ex89 | 23.4 | 86.5 | −50.6 | 6.4 | 21.6 | 82.2 | −16.4 | −313.4 | −124.5 |
| Ex90 | 22.3 | 79.4 | −50.9 | 5.8 | 20.3 | 71.9 | −18.0 | −355.5 | −119.6 |
| Ex91 | 20.5 | 65.6 | −54.4 | 7.6 | 20.9 | 95.6 | −24.7 | −510.5 | −129.4 |
| Ex92 | 18.2 | 54.4 | −52.0 | 8.7 | 20.6 | 99.3 | −25.1 | −535.0 | −127.9 |
| Ex93 | 21.0 | 71.3 | −51.8 | 7.2 | 20.9 | 89.1 | −24.7 | −510.5 | −129.0 |
| Ex94 | 23.4 | 81.4 | −55.6 | 7.2 | 22.5 | 87.7 | −14.5 | −272.2 | −126.9 |

TABLE 13

| | | | CD | CD | CD | MFD | MFD | Cable |
|---|---|---|---|---|---|---|---|---|
| No | ZDW | ZDS | 1267.5 | 1310 | 1374.5 | 1310 | 1550 | Cutoff |
| (Units) | (nm) | (ps/(nm² · km)) | (ps/(nm · km)) | (ps/(nm · km)) | (ps/(nm · km)) | (μm) | (μm) | (nm) |
| Ex61 | 1354 | 0.096 | −9.3 | −4.5 | 2.0 | 8.90 | 10.24 | 1247 |
| Ex62 | 1350 | 0.098 | −9.0 | −4.2 | 2.4 | 9.16 | 10.52 | 1244 |
| Ex63 | 1352 | 0.094 | −8.9 | −4.2 | 2.1 | 8.87 | 10.20 | 1170 |
| Ex64 | 1348 | 0.094 | −8.4 | −3.8 | 2.5 | 8.84 | 10.13 | 1200 |
| Ex65 | 1352 | 0.099 | −9.4 | −4.5 | 2.2 | 9.18 | 10.58 | 1209 |
| Ex66 | 1342 | 0.096 | −7.9 | −3.3 | 3.0 | 9.03 | 10.30 | 1212 |
| Ex67 | 1342 | 0.097 | −8.0 | −3.3 | 3.1 | 9.16 | 10.44 | 1259 |
| Ex68 | 1341 | 0.096 | −7.8 | −3.2 | 3.1 | 9.16 | 10.45 | 1224 |
| Ex69 | 1350 | 0.095 | −8.7 | −4.0 | 2.3 | 9.04 | 10.39 | 1239 |
| Ex70 | 1354 | 0.095 | −9.0 | −4.4 | 2.0 | 8.86 | 10.20 | 1260 |
| Ex71 | 1342 | 0.093 | −7.6 | −3.1 | 3.0 | 8.64 | 9.82 | 1244 |
| Ex72 | 1347 | 0.095 | −8.3 | −3.7 | 2.6 | 8.82 | 10.08 | 1233 |
| Ex73 | 1340 | 0.094 | −7.5 | −3.0 | 3.2 | 8.97 | 10.21 | 1200 |
| Ex74 | 1345 | 0.096 | −8.2 | −3.6 | 2.8 | 9.10 | 10.40 | 1246 |
| Ex75 | 1354 | 0.092 | −8.7 | −4.3 | 1.9 | 8.62 | 9.92 | 1175 |
| Ex76 | 1343 | 0.096 | −8.0 | −3.4 | 3.0 | 9.18 | 10.48 | 1260 |
| Ex77 | 1342 | 0.094 | −7.7 | −3.1 | 3.0 | 8.77 | 9.97 | 1252 |
| Ex78 | 1341 | 0.092 | −7.4 | −3.0 | 3.0 | 8.65 | 9.83 | 1256 |
| Ex79 | 1342 | 0.094 | −7.7 | −3.2 | 3.0 | 9.02 | 10.29 | 1259 |
| Ex80 | 1342 | 0.095 | −7.8 | −3.2 | 3.0 | 9.00 | 10.26 | 1240 |
| Ex81 | 1341 | 0.093 | −7.4 | −3.0 | 3.1 | 8.83 | 10.06 | 1204 |
| Ex82 | 1350 | 0.092 | −8.3 | −3.9 | 2.2 | 8.61 | 9.88 | 1185 |
| Ex83 | 1342 | 0.095 | −7.8 | −3.2 | 3.1 | 9.06 | 10.33 | 1247 |
| Ex84 | 1341 | 0.092 | −7.3 | −3.0 | 3.1 | 8.76 | 9.97 | 1239 |
| Ex85 | 1359 | 0.092 | −9.3 | −4.8 | 1.4 | 8.61 | 9.95 | 1211 |
| Ex86 | 1352 | 0.093 | −8.7 | −4.2 | 2.1 | 8.63 | 9.89 | 1245 |
| Ex87 | 1342 | 0.090 | −7.3 | −3.0 | 2.9 | 8.63 | 9.83 | 1220 |
| Ex88 | 1350 | 0.094 | −8.6 | −4.0 | 2.3 | 8.83 | 10.13 | 1250 |
| Ex89 | 1341 | 0.093 | −7.6 | −3.1 | 3.1 | 8.79 | 10.01 | 1252 |
| Ex90 | 1341 | 0.094 | −7.6 | −3.1 | 3.1 | 8.84 | 10.06 | 1226 |
| Ex91 | 1359 | 0.093 | −9.3 | −4.8 | 1.5 | 8.60 | 9.93 | 1216 |
| Ex92 | 1348 | 0.093 | −8.2 | −3.7 | 2.4 | 8.80 | 10.09 | 1222 |
| Ex93 | 1341 | 0.090 | −7.3 | −3.0 | 3.0 | 8.61 | 9.80 | 1257 |
| Ex94 | 1347 | 0.093 | −8.2 | −3.6 | 2.6 | 8.65 | 9.87 | 1260 |

TABLE 14

| | R15BL | R10BL | R7.5BL | R15BL | R10BL | R7.5BL | |
|---|---|---|---|---|---|---|---|
| No | at 1550 | at 1550 | at 1550 | at 1625 | at 1625 | at 1625 | |
| (Units) | (dB/10turn) | (dB/turn) | (dB/turn) | (dB/10turn) | (dB/turn) | (dB/turn) | BL Type |
| Ex61 | 0.009 | 0.07 | 0.54 | 0.057 | 0.23 | 1.24 | A1 |
| Ex62 | 0.037 | 0.12 | 0.58 | 0.180 | 0.34 | 1.16 | A1 |
| Ex63 | 0.072 | 0.25 | 1.22 | 0.370 | 0.70 | 2.49 | A1 |
| Ex64 | 0.021 | 0.11 | 0.63 | 0.121 | 0.33 | 1.38 | A1 |
| Ex65 | 0.098 | 0.32 | 1.53 | 0.459 | 0.84 | 2.97 | A1 |
| Ex66 | 0.027 | 0.14 | 0.81 | 0.149 | 0.40 | 1.73 | A1 |
| Ex67 | 0.011 | 0.08 | 0.60 | 0.067 | 0.25 | 1.34 | A1 |
| Ex68 | 0.035 | 0.17 | 0.95 | 0.183 | 0.47 | 1.97 | A1 |
| Ex69 | 0.021 | 0.11 | 0.65 | 0.117 | 0.32 | 1.37 | A1 |
| Ex70 | 0.008 | 0.04 | 0.25 | 0.048 | 0.14 | 0.57 | A2 |
| Ex71 | 0.002 | 0.01 | 0.09 | 0.013 | 0.05 | 0.22 | A2 |
| Ex72 | 0.008 | 0.05 | 0.33 | 0.050 | 0.16 | 0.77 | A2 |
| Ex73 | 0.027 | 0.07 | 0.28 | 0.136 | 0.20 | 0.58 | A2 |
| Ex74 | 0.015 | 0.04 | 0.19 | 0.078 | 0.13 | 0.38 | A2 |
| Ex75 | 0.019 | 0.05 | 0.18 | 0.103 | 0.13 | 0.37 | A2 |
| Ex76 | 0.021 | 0.08 | 0.38 | 0.107 | 0.22 | 0.80 | A2 |
| Ex77 | 0.002 | 0.02 | 0.23 | 0.013 | 0.08 | 0.57 | A2 |
| Ex78 | 0.001 | 0.02 | 0.15 | 0.010 | 0.06 | 0.39 | A2 |
| Ex79 | 0.006 | 0.06 | 0.43 | 0.042 | 0.18 | 0.98 | A2 |
| Ex80 | 0.013 | 0.06 | 0.35 | 0.076 | 0.19 | 0.76 | A2 |
| Ex81 | 0.014 | 0.05 | 0.21 | 0.080 | 0.14 | 0.46 | A2 |
| Ex82 | 0.013 | 0.04 | 0.20 | 0.079 | 0.14 | 0.45 | A2 |
| Ex83 | 0.014 | 0.06 | 0.29 | 0.075 | 0.17 | 0.62 | A2 |
| Ex84 | 0.005 | 0.03 | 0.18 | 0.032 | 0.10 | 0.41 | A2 |
| Ex85 | 0.012 | 0.05 | 0.27 | 0.074 | 0.16 | 0.59 | A2 |
| Ex86 | 0.003 | 0.02 | 0.15 | 0.020 | 0.07 | 0.37 | A2 |
| Ex87 | 0.004 | 0.02 | 0.10 | 0.029 | 0.06 | 0.23 | A2 |
| Ex88 | 0.004 | 0.04 | 0.31 | 0.030 | 0.13 | 0.75 | A2 |
| Ex89 | 0.002 | 0.02 | 0.24 | 0.015 | 0.09 | 0.60 | A2 |
| Ex90 | 0.008 | 0.05 | 0.33 | 0.053 | 0.17 | 0.76 | A2 |
| Ex91 | 0.008 | 0.04 | 0.23 | 0.053 | 0.13 | 0.52 | A2 |
| Ex92 | 0.012 | 0.05 | 0.21 | 0.070 | 0.14 | 0.47 | A2 |
| Ex93 | 0.001 | 0.01 | 0.11 | 0.011 | 0.05 | 0.27 | A2 |
| Ex94 | 0.001 | 0.01 | 0.18 | 0.007 | 0.06 | 0.48 | A2 |

The ranges of the values of the different parameters used in the 94 examples listed in the above tables are presented hereinafter, in [Table 15], [Table 16], [Table 17] and [Table 18].

TABLE 15

| Parameter | | r₀ | r₁ | r_{eq} | r₂ | r₃ | Δn₀ | Δn₂ | Δn₃ |
|---|---|---|---|---|---|---|---|---|---|
| Unit | r₀/r₁ | μm | μm | μm | μm | μm | (×1000) | (×1000) | (×1000) |
| Minimum value | 0.05 | 0.19 | 2.61 | 1.94 | 7.83 | 10.88 | 5.86 | 1.18 | −8.39 |
| Maximum value | 0.95 | 2.99 | 5.06 | 3.26 | 8.70 | 13.05 | 8.42 | 2.39 | −3.95 |

TABLE 16

| Parameter | V₀₁ | V₁₁ | V₀₂ | V₁₂ | V₀₃ | V₁₃ | K₁ | K₂ | K₃ |
|---|---|---|---|---|---|---|---|---|---|
| Unit | (μm) | (μm²) | (μm²) | (μm) | (μm) | (μm²) | (μm) | (μm²) | (μm) |
| Minimum | 16.3 | 42.4 | 3.8 | 50.5 | −30 | −652.8 | −58.3 | 18.7 | −132.9 |
| value | | | | | | | | | |
| Maximum | 24.3 | 92.4 | 11.8 | 128.7 | −14.5 | −277.2 | −47.4 | 23.3 | −118.8 |
| value | | | | | | | | | |

TABLE 17

| | | | CD | CD | CD | MFD | MFD | Cable |
|---|---|---|---|---|---|---|---|---|
| Parameter | ZDW | ZDS | 1267.5 | 1310 | 1374.5 | 1310 | 1550 | cutoff |
| Unit | nm | (ps/(nm² · km) | (ps/(nm²-km) | (ps/(nm² · km) | (ps/(nm² · km) | μm | μm | nm |
| Minimum | 1340 | 0.090 | −9.5 | −4.8 | 1.4 | 8.6 | 9.8 | 1170 |
| value | | | | | | | | |
| Maximum | 1359 | 0.099 | −7.3 | −3 | 3.2 | 9.2 | 10.6 | 1260 |
| value | | | | | | | | |

TABLE 18

| | R15BL | R10BL | R7.5BL | R15BL | R10BL | R7.5BL |
|---|---|---|---|---|---|---|
| Parameter | at 1550 | at 1550 | at 1550 | at 1625 | at 1625 | at 1625 |
| (Units) | (dB/10turn) | (dB/turn) | (dB/turn) | (dB/10turn) | (dB/turn) | (dB/turn) |
| Minimum value | 0.001 | 0.013 | 0.090 | 0.007 | 0.048 | 0.224 |
| Maximum value | 0.150 | 0.32 | 1.53 | 0.64 | 0.84 | 2.97 |

Thus, it can be observed from the examples of [Table 3] to [Table 14] and the ranges presented in [Table 15] to [Table 18], that the parameters of radiuses and indexes of the core and cladding of the optical fiber according to the invention, allow to obtain a ZDW which is shifted towards higher wavelengths compared to prior art optical fibers according to the G.652 and G.657 recommendations.

Indeed, the standard fibers, according to the G.657.A1 recommendation, present a ZDW comprised between 1300 and 1324 nm, while the optical fiber according to the invention presents a ZDW comprised between 1340 and 1359 nm, as illustrated by [Table 17]. Such a shift in the ZDW allows to obtain an optical fiber optimized for a use in the O- and E-bands.

Furthermore, the Zero Dispersion Slope (ZDS) of the optical fibers according to the invention is mostly below 0.092 ps/(nm²·km) in Examples 1 to 94, contrarily to the G652 or G657 attributes. Therefore, the optical fibers according to the invention are not compliant with chromatic dispersion attributes of G652 and G657, in particular for the ZDW which is completely different, and for the ZDS in most of the cases.

Moreover, the present invention also allows to obtain an optical fiber with an MFD, a cable cutoff, and bend losses similar to the ones of the G.652 and G.657 recommendations. More particularly, as illustrated by [Table 1] and [Table 18], the optical fibers according to the invention comply with the macrobend requirements of G657A1 or G657A2.

Therefore, the present invention allows to obtain a single-mode optical fiber similar to the standard optical fibers of the G.652 and G.657 recommendations, but optimized to operate with higher wavelength in the O- and E-bands due to a higher ZDW which is obtained with specific radiuses (r₀, r₁, r₂, r₃) and indexes (Δn₀, Δn₂, Δn₃) in the core 10 and cladding 20 of the optical fiber 1.

1. A single-mode optical fiber comprising:
a core having a refractive index n, wherein the core comprises a region in which the value of n decreases from a value n₀ at a radius r₀, to a value n₂ at a radius r₁; and
a cladding having a refractive index n′, said cladding comprising:
a first layer of cladding wherein the refractive index n′ is equal to n₂; and
a second layer of cladding wherein the refractive index n′ is equal to a value n₃ lower than n₂;
a third layer of cladding wherein the refractive index n′ is equal to a value n₄ higher than n₃;
wherein the core radius r₁ is comprised between 2.5 μm and 5.5 μm; and
wherein a refractive-index difference Δn₀=n₀−n₄ is higher than 5.8×10⁻³; and
wherein a refractive-index difference Δn₂=n₂−n₄ is between 1×10⁻³ and 2.5×10⁻³; and
wherein a refractive-index difference Δn₃=n₃−n₄ is lower than 0; and
wherein the refractive-index profile of the core and cladding is defined by the following profile parameters:
$${K}_{1} = {V}_{11} - 5.85 \times {V}_{01}$$
$${K}_{2} = {V}_{02} + 0.65 \times {V}_{01}$$
$${K}_{3} = {V}_{03} - 5 \times {K}_{2}$$
where
V₀₁ is a surface integral of the core;
V₁₁ is a volume integral of the core;
V₀₂ is a surface integral of the first layer of cladding;
V₀₃ is a surface integral of the second layer of cladding;
and wherein said parameters respect the following inequalities:
$$- 59 < {K}_{1} < - 47$$
$$18 < {K}_{2} < 24$$
$$- 133 < {K}_{3} < - 1 18.$$

2. The single-mode optical fiber according to claim 1, wherein the third layer of cladding is composed of silica.

3. The single-mode optical fiber according to claim 1, wherein the profile of the refractive index of the core is trapezoidal, with a ratio comprised between 0 and 1, and preferably between 0.05 and 0.95, wherein said ratio is equal to r₀/r₁.

4. The single-mode optical fiber according to claim 1, wherein the profile of the refractive index or the core presents rounded edges.

5. The single-mode optical fiber according to claim 1, wherein the profile of the refractive index of the core presents an inner central depressed zone, from the center of the core to the radius r₀, wherein r₀ is lower than r₀, and wherein the refractive index n of the core, presents a minimum value at the center of the core equal to n_{0D}, wherein n_{0D} is lower than n₀.

6. The single-mode optical fiber according to claim 1, wherein the region with decrease of refractive index is obtained by gradually changing a concentration of at least two dopants.

7. The single-mode optical fiber according to claim 1, wherein the at least two dopants are chosen among the following elements and/or molecules:
germanium oxide (GeO₂);
fluorine (F);
phosphorus oxide (P_{X}O_{Y});
boron oxide (B_{X}O_{Y});
1 aluminum oxide (Al₂O₃).

8. The single-mode optical fiber according to claim 1, wherein said optical fiber has a Chromatic Dispersion comprised between −9 and +3 ps/(nm·km) in the range of wavelength from 1268 to 1375 nm.

9. The single-mode optical fiber according to claim 1, wherein said optical fiber has a Mode Field Diameter (MFD) at a 1310 nm wavelength which is comprised between 8.6 and 9.2 μm.

10. The single-mode optical fiber according to claim 1, wherein said optical fiber has a Cable cut-off wavelength comprised between 1170 nm and 1260 nm.

11. The single-mode optical fiber according to claim 1, wherein said optical fiber has a Zero Dispersion Wavelength comprised between 1340 and 1360 nm.

12. An optical fiber transmission system wherein it comprises at least one single-mode optical fiber according to claim 1.

13. The optical fiber transmission system according to claim 12, wherein said transmission system has a maximum Transmitter Dispersion Penalty of 1.5 dB.
